(19) United States
(12) Patent Application Publication
(10) Pub. No.: US 2007/0119539 A1
(43) Pub. Date: May 31, 2007

(54) Attachment of Cables to Flexible Fabrics

(76) Inventors: Edward C. Gunzel, Oxford, PA (US); Christopher H. Brennan, New Castle, DE (US); Michael G. Dunham, Newark, DE (US); Andrea Biro, Newark, DE (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/627,084

(22) Filed: Jan. 25, 2007

Related U.S. Application Data
(62) Division of application No. 10/699,109, filed on Oct. 31, 2003.

(51) Int. Cl. B32B 37/12

(52) U.S. Cl. 156/300; 156/304.1; 156/304.3

(57) ABSTRACT

A fabric body or textile comprising a cable or interconnect capable of transmitting data or power is secured to the fabric body or textile surface by a tape. Methods for securing the cable or interconnect system include, for example, garment taping processes. Fabric bodies having the taped cable or interconnect are highly flexible, wash durable and unobtrusive to the user.

### CROSS REFERENCE TO RELATED APPLICATIONS

This application is a divisional application of commonly owned and copending U.S. Ser. No. 10/699,109, filed Oct. 31, 2003.

### BACKGROUND OF THE INVENTION

Electronic devices for personal use have been miniaturized to enable portability thereby enhancing utility and functionality for devices such as laptops, cell phones, calculators, handheld organizers, portable radios and CD players. Sufficient miniaturization has made it possible to integrate electronics into everyday items, such as apparel. For example, many articles of clothing have now been made to incorporate pockets for carrying cell phones, compact disc players, and portable audio players. It is now desirable to integrate the small electronic devices with textiles and garments, dramatically increasing the portability of the devices. Hands-free operation is a goal of many of these efforts.

Recent demonstrations illustrate the integration of electronics into clothing. The textile and electronics industries have initiated joint activity to demonstrate the potential of integration. For example, Levi Strauss and Philips Electronics jointly developed the Levi's ICD+ jacket which incorporated a mobile telecommunications device, portable audio device (an MP3 player), user headphones and a microphone. The jacket was provided with wiring to form an interconnect system, connecting the devices which could be controlled and synchronized with a user keypad (U.S. patent application number 2003/0056969).

A challenge of integrating electronic modules into garments and other flexible fabric bodies is the connection between the modules. At a minimum, the connection between the modules should provide the desired function of transmitting data or power between the modules. However, it is also desirable that the connections are flexible and unobtrusive to the user or wearer of the flexible fabric body, and that the connections reliably transmit power or date between modules as the fabric body is worn or used. Moreover, unless the cables are removed for cleaning the fabric body, the connection must be reliable after washing. Additionally, it is desired that the method of attaching the connections is compatible with processes used in the textile industry. Thus, it is desired that systems for connecting electronic modules in a flexible body have at least the following requirements: transmit data or power between modules, remain unobtrusive to the user, have sufficient durability to withstand rigorous use and cleaning, and integrate into a fabric body using processes compatible with known textile processes.

Attempts to incorporate connections between electronic modules into fabric bodies, i.e., clothing, have included several approaches. For example, electrical interconnects have been incorporated into fabric bodies using relatively stiff cables that are incorporated into gussets or tunnels stitched into the apparel or conductors concealed between textiles (CA2014104). The construction of the Levi's ICD+ garment utilized a similar approach. In stitched or tunnel constructions, rigid cables demonstrate less flex fatigue because they do not readily bend, and often show improved durability compared to thinner more flexible cables or other electronic components. However, while advantageously creating a more durable interconnect system, flexibility and weight are often compromised, and the interconnects fail to be unobtrusive to the wearer. Bulky, stiff cables may even provide points of wear and blistering for the user. Thus, in many applications, such as military, law enforcement, and firefighting, as well as backpacking/hiking, running and even for casual wear, an increase in weight and stiffness in the apparel is an unacceptable compromise for durability.

Another approach incorporates conductive elements into textiles by weaving and knitting them as conductive yarns, wires, fibers and the like. Textiles such as these have been used to make static electricity dissipation garments as taught, for example, in U.S. Pat. No. 6,026,512. Conductive textiles utilize conductive yarns that are often made from metal plated aramid fibers, coated carbon fibers or other similar conductors. Other examples include weaving or knitting conductors directly into the fabric for signal or power transmission (U.S. Pat. No. 5,906,004). The conductive textiles are subsequently incorporated into the body of an apparel item. The usefulness of these garments may be limited due to issues of signal isolation in applications where signal integrity is important. Other limitations inherent in this configuration include lack of durability where conductors in the conductive textiles are not adequately protected from conditions that may be encountered during use or maintenance, such as exposure to water and abrasion. Manufacturing issues arise due to difficulties involving connections at seams and controlling the direction of the circuit across multiple fabric panels. For example, cutting and sewing operations can be significantly impeded when trying to construct a garment with an interconnect that spans multiple panels, particularly where integrated conductors run in only one direction (warp or weft). Further, garments having conductive textile constructs cannot be repaired should the conductors become damaged.

Wilson et al. (WO 01/36728 A1) attempt to overcome some of the existing limitations by forming a knitted, woven or braided textile ribbon with transmission elements running the length of the textile ribbon in place of one or more fibers, and selvage edges. The ribbon textile is then incorporated into a garment between two electronic devices by sewing or intermittently fastening (preferably with hook and loop fasteners) the ribbon textile onto the garment. While this construction may address repairability and certain issues associated with interconnectivity at the seams, it may still have inherent limitations relating to durability and signal integrity. Where the conductive elements are not connected directly and continuously to the body of the textile, movement of the elements during wear and cleaning may limit durability. Moreover, incorporation of a knitted, woven or braided textile ribbon into a garment by sewing or fastening may effect garment aesthetics and complicate garment manufacturing.

In U.S. Pat. Nos. 6,111,233, 6,414,289 and 6,548,789, Rock et al. describe an electrical resistance heating composite fabric. For example, in U.S. Pat. No. 6,548,789, it is taught that electrical resistance heating elements such as conductive yarn are embroidered or adhered to a textile surface, and the resulting composite fabric may be incorporated into garments. A barrier layer may optionally be positioned on the textile surface and attached, e.g. by adhesive or lamination, on the same or opposite textile surface as the electrical resistance heating elements. It is taught that simple structures such as heating blankets may be made from composite fabrics. Alternately, composite fabrics can be incorporated into more complex shapes such as articles of apparel, for example, where a pair of the composite fabrics can be incorporated into a jacket. However, challenges associated with manufacturing integrated textiles into complex three dimensional structure, such as pattern cutting position, sewing through the electrical connections, and connections at the seams, may make this approach impractical for interconnections within three dimensional fabric shapes. Where panels of fabrics with integral textiles are used, forming a practical connection between the panels remains an outstanding challenge. Moreover, lamination or adhesion of a barrier layer over a textile surface may affect garment flexibility and aesthetics. Additionally, the integrated nature of this construct does not lend itself to repairability or replaceability of the electrical system, a feature that may be desirable in applications where the garment will outlast the electrical system.

It is desirable to have a fabric body having an interconnect system which is durable in true high flex applications as well as being wash durable. It is further desirable that the interconnect system is incorporated into the fabric body without compromising garment comfort or aesthetics, and that a fabric body having an interconnect system is conformable to the body, and unobtrusive to the wearer with no stiff or hard points to wear against the user. It is further desired that these constructs remain flexible, for example, for folding and packing, such as in the case of a tent.

Further, it is desirable to have a fabric body in which the interconnect system may be easily removed or repaired. This is particularly desirable in high flex applications where the garment may outlast the interconnect system or electronic modules. Moreover, it is desirable for a fabric, such as a garment to be retrofitted with an interconnect system which is made integral with the garment, after the garment has been manufactured.

It is further desirable to have a process for incorporating or replacing electronic components, such as cables and interconnects into three dimensional flexible fabric bodies, such as articles of apparel using technology known in the field of garment manufacturing, and which may be performed on a finished or partially finished flexible fabric body.

### SUMMARY OF THE INVENTION

The current invention successfully resolves many of the issues encountered by previous approaches to incorporating interconnect systems into garments. The present invention is directed at a fabric body comprising a flexible, lightweight interconnect system for clothing and other textile structures. In one embodiment, a connection is provided by flexible cables, secured between a tape and the fabric body. The flexible cable and the tape provide a durable connection that is unobtrusive to the user.

The current invention also provides processes for incorporating interconnect systems into three dimensional fabric bodies that address outstanding challenges related to manufacturing garments with interconnect systems. For example, one embodiment of the current invention utilizes a continuous garment taping process in combination with flexible cables, permanently fixing the cables to the fabric body across multiple fabric panels or to a textile structure with a tape comprising an adhesive. Preferred processes provide for integrating the cables into a previously manufactured garment assembly. In a further embodiment, a tape comprising a hot melt adhesive is used to secure a cable to a fabric body or textile, creating a removable and repairable interconnect system.

Surprisingly, it was found that taping cables into a fabric body or textile results in wash durable interconnect systems having enhanced durability compared to untaped systems, while demonstrating comfort, flexibility and good aesthetic properties in fabric bodies. It was further found that a wash durable interconnect system could be integrated into a garment without noticeably impacting the hand, weight or aesthetics of the garment. It was further surprisingly found that flexible, unobtrusive, wash durable structures could be made using techniques compatible with processes used in garment manufacturing.

### DESCRIPTION OF THE FIGURES

FIG. 1 is a top planar view of a textile surface with a ribbon cable secured by a tape comprising an adhesive.

FIG. 2 is a cross-sectional view of a textile surface with a ribbon cable secured by an adhesive tape

FIG. 3 is a cross-sectional view of a textile surface with several conductive cables secured to the textile by a tape comprising an adhesive.

FIG. 4 is a diagrammatic representation of a garment with an attached interconnect extending from a jacket body portion to the hood.

FIG. 5 is a view of a segment of a continuous seam sealing machine and a configuration for a process of concurrently placing taping cables to a textile surface.

FIG. 6 is a view of a segment of a crossover press machine and a configuration of one process of taping a cable to a textile surface.

FIG. 7 is a cross-sectional view of a textile surface with a ribbon cable secured to the textile by a tape comprising an adhesive on upper and side cable surfaces, and an adhesive on a lower cable surface.

### DETAILED DESCRIPTION OF THE INVENTION

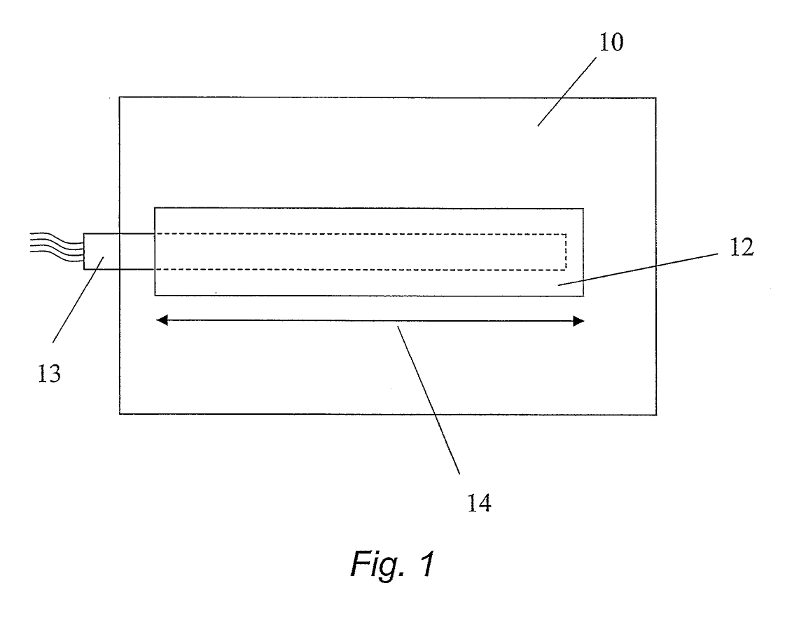

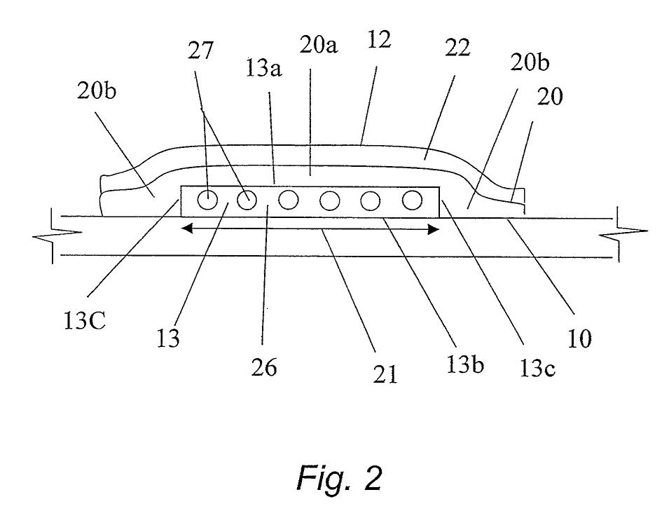

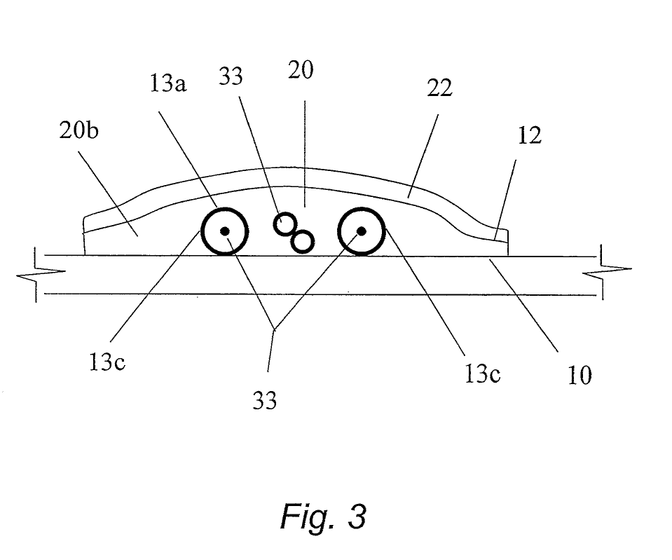

As best illustrated by the figures of the present invention, FIG. 1 illustrates a structure of the present invention (1) comprising a textile surface (10), and a tape (12) and a length of cable (13) that extend across at least a portion of the textile surface (10), wherein the cable is secured between the textile and the tape (12), and wherein the tape substantially and continuously covers the cable length (14). FIG. 2 depicts a cross-section of a structure of the present invention. The structure comprises a textile surface (10), tape (12) comprising an adhesive (20) and at least one additional layer (22), and a cable having a width (21), the cable comprising upper, lower and side surfaces (13a, b, and c, respectively), wherein the tape covers the upper surface (13a) of the cable, the tape adhesive (20a) adhering to at least the cable upper surface. In one embodiment as illustrated in FIG. 2 the tape adhesive (20b) adheres to cable side surfaces (13c) and extends slightly beyond the side surfaces onto the textile, the adhesive (20b) adhering to the textile surface (10), and thereby securing the cable between the tape and the textile surface (10). FIG. 3 depicts a cross-section of a further structure of the present invention, the cross-section illustrating a textile surface (10) and several cables (33), wherein the cables are secured between the textile surface (10) and a tape (12). The tape comprises an adhesive (20) and at least one additional layer (22), the tape adhesive (20) covers and adheres to cable upper (13a) and side (13c) surfaces, the adhesive (20b) further extending beyond cable side surfaces adhering to the textile surface (10).

Preferably, the cable is secured between a tape and a textile, the cable being taped continuously along the entire cable length that extends across the textile. Further, the cable should remain durably secured to the textile surface upon washing and high flex applications. By the phrase “remains secured”, it is meant that the tape remains attached to the textile with no visible separation between the covering tape and the textile surface, and the cable therefore remains in place. By securing the cable between the tape and the textile surface, it is believed that the effects of strong forces, tangling or torsion exerted on cables during wear, use and maintenance, such as washing, which often result in failure of the cable or connection, are minimized in the present invention resulting in improved durability of the connection system. Moreover, by securing the cable between the tape and the textile surface, it is further believed that the cable will be protected from environmental conditions such as rain and snow and contaminants such as sweat, body oils, and chemicals such as insect repellant, diesel fuel and the like.

It is preferred that a textile structure comprising the cable attached to the textile surface is highly flexible, and the cable is durably secured to the textile surface upon washing and high flex applications. It should be recognized by those skilled in the art that “textile” is meant here to describe wovens, non-wovens, knits, braids and composites made therefrom. Particularly useful composites include but are not limited to, textile laminates comprising foams, films, membranes, and coatings. Preferred textiles are waterproof, or liquidproof. By “liquidproof” it is meant that the textile passes a Suter test when performed substantially according to the method described herein. Particularly suitable textiles include liquidproof, moisture vapor permeable textiles, particularly textiles comprising expanded polytetrafluoroethylene (ePTFE). For the purposes of the present invention, the definition of “textile” includes films, particularly where the films are incorporated into a fabric body, such as in the form of a laminate or panel, or form all or a part of a fabric body.

Tapes preferred for use in the present invention are narrow, flexible, continuous strips having a width which when applied over the cable, extends just slightly beyond the cable width to adhere to the textile or fabric body. In one embodiment, the tape is a flexible, durable tape comprising at least two layers, an adhesive layer and at least one additional layer. Adhesives suitable for use in the tape include thermally and chemically activated adhesives. One class of preferred adhesives are thermoplastic adhesives having processing temperatures lower than the thermal stability range of the cable and textile. Preferred thermoplastic adhesives include thermoplastic polyurethanes and polyamides. Another preferred class of adhesives are thermoset adhesives having activation temperatures lower than the thermal stability range of the textile and cable. A particularly useful class of thermoset adhesives is silicone. Also preferred are elastomeric adhesives. Other adhesives such as, for example, polyvinylchloride, polyesters, and olefin polymer adhesives may be suitable for use as tape adhesives. Further, other adhesives such as pressure sensitive adhesives may be suitable in certain applications.

Preferred two layer tapes comprise an adhesive and at least one additional layer that remains solid above the processing temperature of the tape adhesive. Additional layers may, for example be comprised of a liquidproof film such as expanded polytetrafluoroethylene (ePTFE), polyurethane, polyvinylchloride, polyester and the like. Particularly preferred is a two-layer tape comprised of an adhesive and a layer comprising polytetrafluoroethylene (PTFE), most preferably expanded polytetrafluoroethylene. A particularly preferred three layer tape is comprised of a polyurethane adhesive, a layer comprising PTFE, most preferably ePTFE, and a knit layer. Additional layers may also comprise knit layers, for example, to provide abrasion protection for the tape and provide a fabric inner surface that is comfortable on the skin of a wearer or user. Tapes may further comprise other layers such as textiles, additional adhesive layers that may be the same or different, and coatings, such as water repellant coatings. To be suitable for use in the present invention it is preferred that tapes are wash durable and are able to remain secured to the textile or fabric body after multiple wash dry/cycles.

The structure of the present invention further comprises a cable or interconnect system. It should be understood by one skilled in the art that “interconnect system” refers to a construct capable of transmitting power or data, and is comprised of cables, including branched cables, and connectors for connecting the cables to devices, such as electronic modules. By the term “cable” it is meant a conductor having one or more transmission elements capable of transmitting power or data, such as electrical data, optical data, and electromagnetic signals, between electronic modules or devices. Cables are therefore terminated at cable ends with connectors forming the interconnect system. As illustrated (FIG. 2), cables (13) may comprise an insulating jacket (26) and conductive elements (27). Those skilled in the art would recognize that the term “cable” it is meant to include for example, ribbon cable, twisted pairs, coaxial cable, and the like. Cables having conductive elements may have any number of elements depending on the application. In some embodiments, for example where the elements are electrically conductive, it may be preferred that multiple transmission elements remain isolated, e.g. electrically isolated, from each other. One preferred cable for such applications is a microribbon cable having multiple elements and a thickness of less than or equal to 0.5 millimeters, preferably less than about 0.3 millimeters, and further preferred, less than about 0.2 millimeters.

Cables may have more than one insulating jacket or multiple insulating layers surrounding conductive elements. Alternating layers of insulating materials and conducting materials may be further required for example, where it is necessary to provide electromagnetic interference (EMI) shielding. It is preferred that cables have at least one insulating jacket or layer (26) which is thermally stable at the processing temperature of the tape adhesive, in applications where it is desirable to secure a cable to a textile surface using a hot melt adhesive such as a hot melt polyurethane adhesive. Insulating layers may comprise electrically insulating materials such as ePTFE, PTFE, fluorinated ethylene propylene, polyvinylchloride, polyimide, silicone, polyethylene and the like. One preferred cable comprising an insulating layer is a micro-ribbon cable comprising a PTFE or ePTFE layer or jacket, for example, such as multi signal transmission cables (W.L. Gore & Assoc., Inc., Elkton, Md.). The selection of cables and insulating material may depend, for example, on the processing temperature used to secure the cable, as well as the electrical performance, durability, and flexibility requirements specified by the application. Thin and narrow conductive cables, such as the microribbon cable, are advantageous in garment applications, where for example they remain visibly unobtrusive after being secured.

Cables of the present invention are defined by a length, and have upper and lower surfaces, and side surfaces, in relation to the position of the cable to the textile and tape. Thus, for purposes of the present invention, a length of cable such as a flat, round or twisted pair, has upper and lower cable surfaces, the cable upper surface being the portion of that length of cable nearest the tape, the cable lower surface being the portion of the length of cable nearest the textile surface, and the cable side surfaces being the portion between the cable upper and lower surfaces.

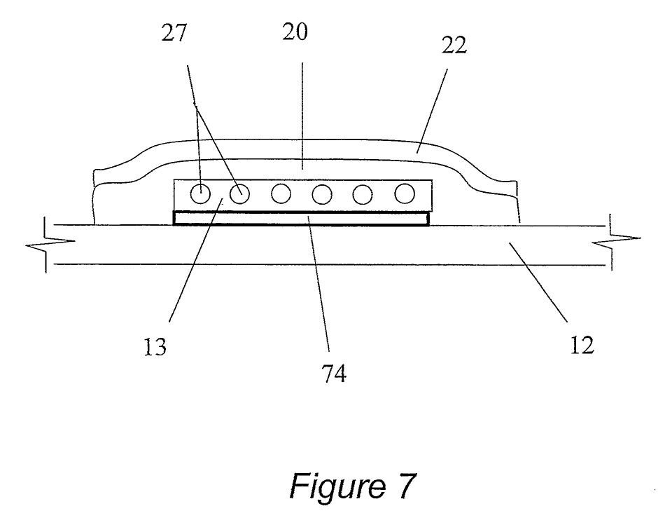

In a further embodiment illustrated in FIG. 7, a structure is provided comprising a tape (12) comprising a tape adhesive (20), a textile surface (10) and a cable (13) between the tape and the textile surface, wherein an additional adhesive (74) is located between a cable lower surface and the textile surface. In one embodiment, a cable may comprise an adhesive component thereby having an adhesive on a cable surface, such as a cable lower surface, prior to extending the cable onto the textile surface. In another embodiment, an additional adhesive is applied to the textile prior to placement of the cable on the textile surface. The cable is then adhered to the additional adhesive and the textile surface. Either configuration may be useful for holding the cable in place during the taping process. Preferred additional adhesives suitable as a component of the cable or for placing directly on the textile include pressure sensitive adhesives.

In another embodiment, cables and tape may be preassembled into a single structure prior to placing the tape on a textile. For example, cable may be incorporated into a tape adhesive layer, such as by embedding a cable into the adhesive. Alternately, a cable may comprise one of the additional tape layers, or the cable may be incorporated into the one or more additional tape layers such as by lamination.

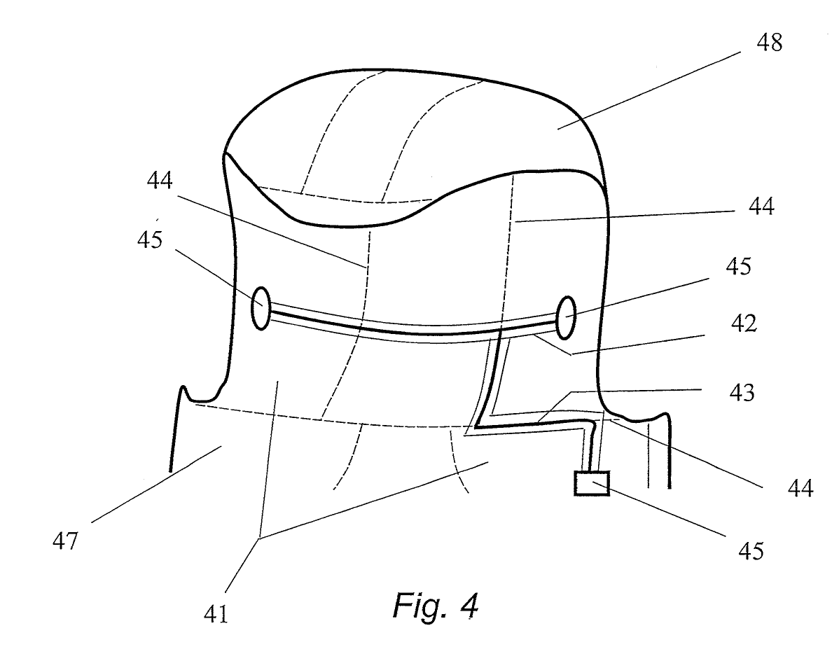

FIG. 4 is exemplary of a fabric body of the present invention, specifically, a garment or a jacket having a hood. By the term ‘fabric body’ it is meant a three-dimensional or multiple panel textile structure. Examples include, but are not limited to, a personal shelter including a tent and a bivy bag, a garment including a hat, jacket, shirt, sock, glove, hood and the like, and luggage, backpacks, and the like. Fabric bodies comprising three dimensional textile structures may comprise at least one textile panel, and preferably at least two joined textile panels, where one or more panels may be joined, for example, by welding or sewing. Three dimensional textile structures may therefore further comprise seams, for example, where at least two textile panels are joined, or where ends of a single panel are joined. As illustrated in FIG. 4, a fabric body comprising a hooded jacket comprises at least two joined textile panels (41) and a seam (44). A jacket body (47) and a hood (48) are formed from at least two joined textile panels defining at least one seam (44) wherein a length of cable (43) is routed between electronic modules (45) positioned in or on the jacket body and hood. The length of cable (43) and a tape comprising a tape adhesive (42) extend across at least a portion of the textile panels and extend across seams (44). The length of cable that extends across the textile panels is substantially and continuously covered by the tape (42). Preferably the tape adhesive adheres to the length of the cable along a cable upper surface and extends beyond cable side surfaces onto the textile securing the cable between the tape and the textile panels.

A preferred embodiment is therefore directed to a fabric body comprising at least two joined textile panels and a length of cable having cable side surfaces, wherein the cable is extended across at least a portion of at least two textile panels. The embodiment further comprises a tape comprising an adhesive that covers and adheres to the length of cable, wherein the adhesive extends beyond cable side surfaces onto the textile panels and adheres to the textile panels, and wherein the cable is secured between the tape and the textile panels. The fabric body may further comprise an additional adhesive between the cable and the textile panels. For use in transmitting power or data, the ends of a length of cable are terminated with connectors. Preferably, at least one surface of a connector is covered with a tape adhesive and secured between the tape and the textile.

A further preferred fabric body comprises a textile having a surface, and a length of micro-ribbon cable comprising an insulation layer extended across at least a portion of the textile. A preferred tape comprising a thermally stable layer and a polyurethane adhesive, covers the length of micro-ribbon cable, and the polyurethane adhesive adheres to the cable and extends beyond cable side surfaces and adheres to the textile surface. The cable is secured between the textile surface and the tape. Preferably, the insulation layer and the thermally stable layer are thermally stable above the processing temperature of the tape adhesive.

In one preferred embodiment, the fabric body comprising cables secured by tape is liquidproof. By liquidproof is meant that the fabric body including the seams joining textile panels passes a Suter test when performed substantially according to the method described herein. Further, the tape comprising adhesive can be applied to seams to provide a liquidproof seal. Where the cable is extended along a seam the tape functions to secure the cable to the fabric body and to provide a liquidproof seal to the seam. Thus, the liquidproof fabric body preferably comprises liquidproof textile panels, a tape comprising an adhesive and a cable wherein the tape secures the cable to the textile. Where the cable is extended along a seam, the tape comprising the adhesive seals the seam, thereby forming a liquidproof sealed seam comprising a cable.

Another embodiment of the present invention is directed to a process for assembling fabric bodies having a taped cable, including an interconnect system. A method of assembling a fabric body having a cable comprises joining at least two textile panels to form a fabric body comprising a seam and extending a length of cable having cable side surfaces, across the seam onto a portion of at least two textile panels. Further, a tape is provided comprising an adhesive, comprising adhering the adhesive to the cable, covering the cable length and extending beyond the cable side surfaces. The tape adhesive adheres the tape to the fabric body, thereby securing the cable to the fabric body.

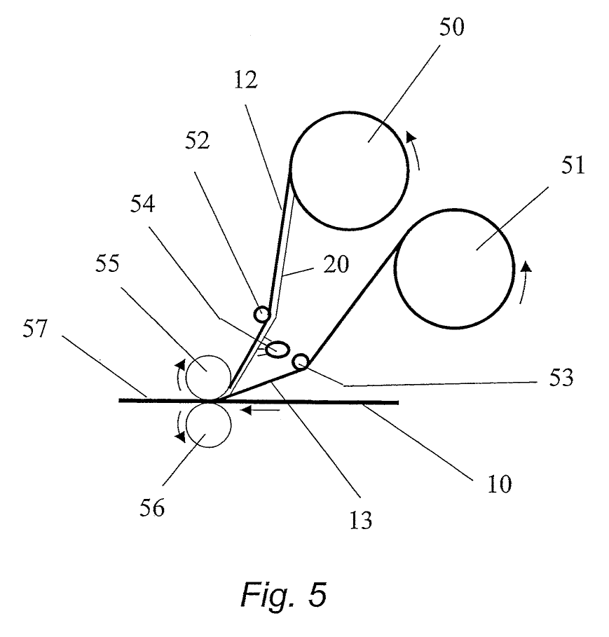

It is known in the field of high performance garments to use garment taping processes to apply tape, for example, a seam sealing tape to the seams of garments, rendering them liquidproof. Garment taping can be accomplished by several machines or processes known in the art of seam sealing, for example, a Gore Model 5000 seam sealing machine (W.L. Gore & Assoc., Inc., Elkton, Md.), or seam sealing machine manufactured by Pfaff Industrie (Kaiserslautern, Germany). In one embodiment, a method comprises providing a garment seam sealing machine that provides tape in a continuous supply such as a reel or roll and applying tape to a textile or a fabric body in a continuous process, suitable for long lengths of tape. FIG. 5 illustrates a segment of a seam sealing machine used in the present invention. The machine of FIG. 5 is depicted as having two feed reels, a tape feed reel (50) and a cable feed reel (51). Currently in garment taping processes it is only known to provide a tape in a continuous supply such as a reel (50). Thus, by the phrase “garment taping process” it is meant a process using a machine, such as a seam sealing machine or crossover press, comprising the steps of providing a tape (12) comprising a layer of adhesive (20) and applying heat to the tape (12) to melt the adhesive (20), for example, by a hot air nozzle (54) or other heat source. The method further comprises providing a textile or fabric body (10), and placing the tape having the melted adhesive on the textile or fabric body, applying pressure to the textile or fabric body and tape, and adhering the tape to the textile or fabric body.

Thus, the present invention discloses a method of applying a cable to a fabric body or textile surface using a garment taping process comprising the steps of providing a fabric body comprising at least one textile panel or a textile surface, extending a length of cable across at least a portion of the textile, providing a tape comprising a tape adhesive, and securing the length of cable to the textile with the tape, wherein the tape is applied to the length of the cable by a garment taping process. In one embodiment, the tape and cable are concurrently applied to the textile, for example, by using a seam sealing machine wherein the cable (13) is preferably fed from a continuous supply such as a cable feed reel (51). In this embodiment, the method comprises providing the tape (12) comprising a layer of adhesive (20) and at least one additional layer (22) that remains solid above the processing temperature of the adhesive, the tape preferably provided in the form of a roll (51), and applying heat to the tape (12) to melt the adhesive (20) by a hot air nozzle (54) or other heat source. The method further comprises providing a textile (10) and a cable (13) which is supplied by a roll or reel (51), and feeding the textile, the tape having the melted adhesive, and the cable, between two nip rollers (55) and (56) and pressing the cable between the tape and the textile, the tape continuously covering the length of cable, adhering the tape to the textile and securing the cable to the textile. In a preferred embodiment the tape and cable are provided or fed concurrently over guide rollers (52 and (53) which align the tape and the cable, centering the cable to the width of the tape, prior to feeding the components between nip rollers.

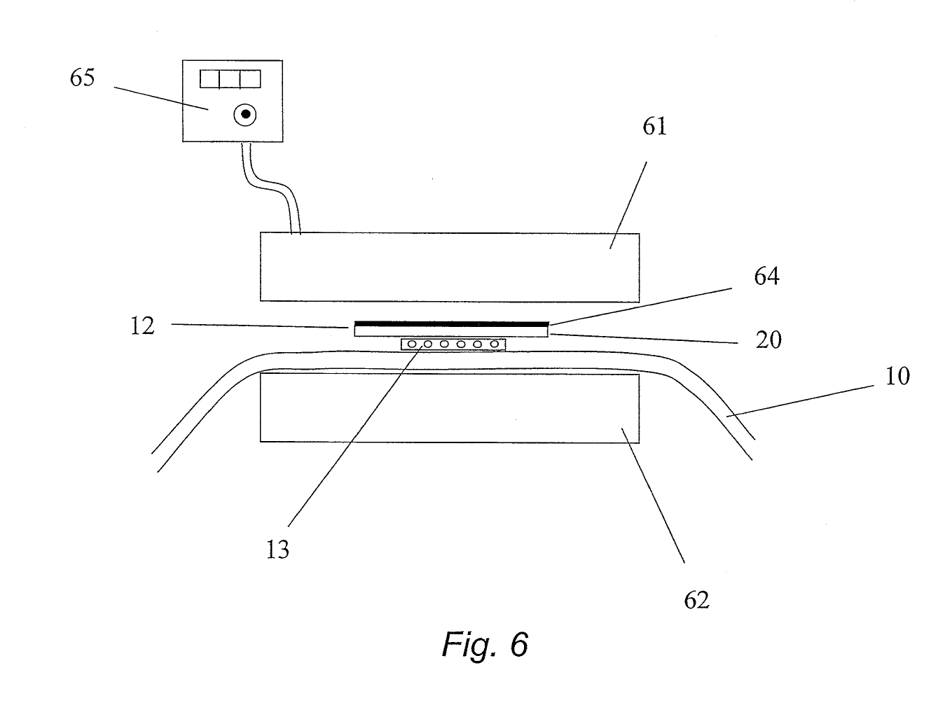

Another example of a garment taping process suitable for use in the present invention is a process referred to as a crossover press, utilizing a press such as, for example, Crossover Press Model 994-GS (available through George Knight, Ltd., Brockton, Mass. or W.L. Gore & Assoc., Elkton, Md.). Crossover pressing may be used for applying tape to small areas or detail taping, for example, for securing connectors of interconnect systems to textiles or fabric bodies, for heating and pressing of areas that are difficult to obtain a seal, such as places where two lengths of tape intersect each other. However, crossover pressing may also be used to integrate cables or interconnect systems into textiles or fabric bodies. FIG. 6 illustrates a segment of a small press and a configuration comprising a textile or fabric body (10), a tape (12), and a cable (13) stacked on a lower platen (62) comprising an upper surface of a high temperature elastomeric foam on its upper surface. A heated upper platen (61) is then pressed down on the tape, melting the adhesive (20) and pressing the tape and cable to the textile (10).

Thus, a method is also directed to a process for taping cables to a textile or fabric body comprising providing a press comprising an upper platen (61), a lower platen (62), and preferably a means of heating controllably one or both platens (65), providing between the upper and lower platens, a textile, providing a tape comprising an adhesive and at least one additional layer that remains solid above the process temperature of the adhesive, and providing a cable between the textile and the tape adhesive. The method further comprising the steps of compressing the upper and lower platens together, melting the tape adhesive, adhering the adhesive to the cable, and adhering the tape to the textile thereby securing the cable between the textile or fabric body and the tape. The method may also comprise the step of covering a length of cable with the tape adhesive prior to providing the tape or cable between the platens.

Preferably, the textile is a fabric body such as a garment, or other fabric shape. In one embodiment prior to the step of covering the length of cable, the method may comprise the step of melting the adhesive. A preferred method comprises covering the length of cable with the tape adhesive, extending the tape adhesive beyond cable side surfaces onto the textile, and securing the cable to the textile by a garment taping process. More preferably, a method is disclosed comprising covering the length of cable on the cable upper surface, and applying pressure to the tape, cable and textile, securing the cable between the textile and the tape.

Preferred is the application of an additional adhesive, preferably a pressure sensitive adhesive tape, to the lower side of the cable. The cable may then be easily routed in the fabric by hand and will maintain its position in curves and turns until it is secured to the fabric body by the tape. A method of assembling a textile or fabric body therefore further comprises extending the cable comprising an adhesive over at least a portion of the textile or garment, and adhering or fixing the cable to the textile or fabric body prior to adhering the tape adhesive to the cable and securing the cable to the textile surface or fabric body. Alternatively, where an adhesive may be applied to the textile surface or fabric body prior to providing the cable over a portion of the textile surface, a method of assembly further comprises providing an additional adhesive to at least a portion of the textile surface or fabric body, providing a length of cable onto a portion of the additional adhesive, adhering or fixing the cable to the textile or fabric body, prior to adhering the tape adhesive to the textile or fabric body.

In another method of the present invention, the cable and tape are extended along a seam in the fabric body, and the cable is secured to the textile by the tape comprising the method steps of providing a fabric body comprising a liquidproof textile and a seam, extending a cable along the seam, providing a tape comprising an adhesive, melting the tape adhesive and pressing the tape comprising the melted adhesive onto the liquidproof textile, securing the cable between the tape and the textile, wherein the resulting sealed seam comprising a cable is liquidproof.

It has been found that where textiles or fabric bodies are integrated with cables or interconnect systems using the processes of the present invention, the cables or interconnect systems are unobtrusive to the wearer. In a preferred embodiment, where the cable or interconnect system is applied to an inner surface of a garment or other fabric body, the attachment of the interconnect system or cable to the fabric is not visible on the outer surface.

It is known in the textile industry that durability and flexibility are critical for many application in which the fabric bodies of the current invention might be used, such as backpacking, hiking, casual wear, law enforcement, workwear, military, firefighting, and the like. In particular, it is recognized that wash durability and flex and abrasion subject the fabric body to extremely harsh conditions in use. Specifically in light duty applications it is important that the fabric body and any components attached to it survive at least two (2) wash/dry cycles. Heavy use garments may require even more wash durability. Wearing durability is measured using the Wet Flex And Abrasion test described herein to simulate folding, twisting, and rubbing to which garments are subjected in field wear. It is desirable that fabric bodies and attachments survive at least two (2) hours, thought preferably more.

It was surprisingly found that the textiles and fabric bodies in which cables or interconnect systems were taped in using methods of the present invention are very durable during use and maintenance. Preferred embodiments of the present invention are textiles or fabric bodies having interconnect systems or cables which remain secured to the textile or fabric body for at least 2 wash/dry cycles, and most preferably, for at least 5 wash cycles. By the “remains secured” it is meant that the cable or interconnect systems remains secured to the textile or fabric, wherein there is no visible separation between the tape comprising the adhesive and the textile or fabric. Further preferred, are textiles or fabric bodies having interconnect systems or cables secured by the methods of the present invention, where the transmission of data or power is maintained after washing. Preferably the direct current (DC) resistance of a conductor in the cable or interconnect system is less than about 100 ohms per meter after two (2) wash/dry cycles, and most preferably less than 100 ohms per meter after (5) wash/dry cycles. Also preferred are textiles of fabric bodies where the direct current (DC) resistance of a conductor in the cable or interconnect system is less than about 100 ohms per meter after ten (10) hours of wet flex and abrasion, and most preferably after twenty (20) hours of wet flex and abrasion.

Additionally, it is known that flexibility of fabrics is important to the wearer. Bending stiffness, as measured by the method described herein, is known by those skilled in the art to be an important component of the flexibility, softness, or hand of a fabric. Preferred are fabric bodies and textiles of the present invention comprising cables secured according to the methods of the present invention have with a Handle-O-Meter bending stiffness less than 1000 grams, preferably less than or equal to 500 grams, and most preferably less than or equal to 250 grams when tested according to the method described herein for Bending Stiffness.

The following tests were used for assessing some of the properties of a few of the embodiments of the present invention.

### Test Methods

### Test Method for Conductivity after Continuous Wet Flex and Abrasion

This method was used for an accelerated indicator of wear or use durability over time. Samples prepared according to the Examples of the present invention were tested. A series of 36 cm by 71 cm samples of a textile surface were cut. Cables of about 55-70 cm in length were fixed to the textiles as described in the Examples.

Further, after the cable lengths were fixed to the textiles as described in the Examples, whether taped or routed through tunnels, the cables were additionally secured at each end of the cable with about six (6) cm of tape according to the methods used in the appropriate Example of the present invention. This was done to prevent damage to unsecured ends of the cables. About 0.75-1.5 cm length of cable at either end of the cable was allowed to extend beyond the tape for an initial resistance assessment.

The samples were placed in a Kenmore washer (Sears, Chicago, Ill.), modified to run in a continuous manner. If needed, ballast of the same textile surface was added to ensure the total wash load is 1 kg +/−0.1 kg. The wash drum was filled with softened water at 20° C.+/−5° C. and the samples of textiles with the attached cables were subject to wash running in a continuous agitation manner. After agitating for two (2) hours, the samples were hung to air dry. The samples were assessed after every two (2) hours of wet flex and abrasion to determine whether the cables remained electrically continuous.

Electrical continuity was ascertained using a Fluke 21 III model multi-meter, by measuring DC resistance of the conductor in the cables. To accurately assess the resistance of the cables, the samples were stripped of about 0.5 cm of the tape securing the ends of the cable to the textile and (where applicable) any protective insulation on the cable. This stripping was repeated for each two (2) hour increment to be sure that a fresh conductor end was tested each time. The Wet Flex and Abrasion testing was continued in two (2) hour increments until it was determined that the sample failed.

Cable samples were considered to have failed when the direct current DC resistance exceeded 100 ohms. In order to avoid erroneous results, failed samples were stripped of tape and assessed in multiple locations along the taped end and subsequently the cable length to ensure the failure was in the cable and not due to high fatigue of exposed cable ends. The durability rating of the samples for this test was reported as the number of continuous wash hours at which the sample failed. In cases where more than one sample was tested, the average was reported.

### Test Method for Bending Stiffness Testing (Using Handle-O-Meter)

Bending stiffness, sometimes called Hand, was tested on cables and cables secured to fabric by the methods of this invention using a Handle-O-Meter (Model 211-5 Thwing Albert Instrument Company, Philadelphia, Pa.). A 1000 gram beam was used to push test specimens through a 1.2 cm slot. The instrument measures the force resisting the movement of the test specimen through the slot. This resistance force, related to the bending stiffness of the fabric, was measured and displayed digitally. The peak resistance force was recorded and used to compare samples. For cables secured to textiles by tape, the sample size is 10 cm by 10 cm. For unattached cables, the sample was the cable itself.

In a typical test of a textile comprising a cable secured by tape or an unattached cable, the sample was placed on the equipment such that the cable runs perpendicular to the slot. The test is initiated, causing the beam to lower and the sample to be forced through the slot. The peak resistance force value was recorded. The same sample was then turned over and rotated 180 degrees to bend at a different site. The test was repeated and the peak resistance force recorded. The two peak resistances are averaged and reported as the hand number or bending resistance in grams force. At least two samples of the same configuration are tested, with results reported as an average.

### Test Method for Wash/Dry Cycles

To determine the wash durability of a sample, the sample was washed and dried generally following the conditions outlined in ISO 6330:1984 Procedure No. 3B. Specifically, a sample was loaded in a four (4) pound (about two (2) Kg) load of laundry into a top loading washing machine set to a medium water level (about 18 gallons, or equivalently 0.0681 m³), hot water temperature (about 140° F., or equivalently, 60° C.), warm rinse cycle and heavy duty wash cycle set for 10 minutes, with about 90 g of TIDE® powdered laundry detergent. The sample was dried in a rotating dryer on a Hot setting for about 35-45 minute drying time. This wash/dry regimen was repeated five times. For the textiles comprising a cable secured by tape of this invention, the tape's appearance was assessed and the electrical direct current resistance of the cables was measured using the Fluke 21 III multimeter by contacting the board conductors on either end of the cable.

### Suter Test for Liquidproof Textiles and Seams

To determine whether the textile and seams of a fabric body made from the structure of the present invention are liquidproof, the Suter test procedure is used, which is based generally on the description in ISO 811-1981. This procedure provides a low pressure challenge to the sample being tested by forcing water against one side of the test sample and observing the other side for indication that water has penetrated through the sample.

The test sample was clamped and sealed between rubber gaskets in a fixture that holds the sample so that water can be applied to an area of the sample 3 inches in diameter (7.62 cm). The water was applied under air pressure of 1 psig (0.07 bar) to one side of the sample. In testing a fabric laminate, the water would be applied to the face or exterior side. In testing a seam, water was applied to the face side of the sample, and the opposite side, or seam backer layer, was observed for leaks.

The opposite side of the sample was observed visually for any sign of water appearing (either by wicking or the appearance of droplets) for 3 minutes. If no water was observed, the sample is deemed to have passed the test and the sample is considered liquidproof.

### EXAMPLES

### Example 1

A 36 cm by 71 cm textile panel was formed having a cable secured with an elastomeric thermoplastic polyurethane adhesive tape.

A roll of conductive silver tape (3M electrical tape, item 3224-1, 3M Company, St. Paul, Minn.) was slit into strips of 0.32 cm width by 66 cm length was applied to the film side of a two-layer (2L) GORE-TEX® laminate (MI260 fabric comprising ePTFE, W.L. Gore & Assoc., Inc., Elkton, Md.). The cable was subsequently secured between the textile and a tape (GORE-SEAM® tape comprising Nylon 66 knit, ePTFE membrane, and 0.16 mm of polyurethane adhesive, P/N 6GTAJ025POLNM, WL Gore & Assoc., Elkton, Md.). To accomplish this, a GORE™ seam sealing Machine Model 5000E (W.L. Gore & Assoc., Inc, Elkton, Md.) was used to apply the tape using an air temperature of about 550° C., a running speed of about 3.7 meters/minute, and an air pressure of about 103.4 kPa. The tape covered the length of the conductive silver tape, extending beyond the side surfaces of the conductive silver tape, the seam tape adhering to the laminate.

The resulting fabric panel was washed according to the method described above for continuous wet flex and abrasion, for two hours. The DC resistance of the fabric panel was measured as described above before and after washing and remained substantially unchanged, having an initial and subsequent resistance of about 0.2 ohms.

### Examples 2-6

Conductive cables were secured to a similar 2L MI260, as described in Example 1, with a two layer (2L) GORE-SEAM® Tape (Item # 4GNAL022NAT, W.L. Gore & Assoc., Inc., Elkton, Md.) in a manner substantially similar to the method of Example 1. The Gore seam sealing machine was used to secure the cables between the laminate and the tape, having an air nozzle temperature of about 625° C., a sealing speed of about 4.6 meters/minute, and air pressure of about 103.4 kPa.

The following cables were secured between to panels of 2L laminate and the tape, being taped continuously along the length of the cable:

| Example No. | Conductor Description |
|---|---|
| Ex. 2 | MSTC-32 conductors* (containing 42 AWG conductors) |
| Ex. 3 | MSTC-16 conductors* (containing 42 AWG conductors) |
| Ex. 4 | 3M conductive silver tape slit to a 0.6 cm strip |
| | (described in Example 1) |
| Ex. 5 | 3M conductive silver tape slit to a 0.3 cm strip** |
| Ex. 6 | Microflat cable* (containing four 46 AWG conductors) |

*W. L. Gore & Assoc., Inc. Elkton, MD.
**The 3M Company, St. Paul, MN.

The laminates having conductive cables secured thereto were tested according to the method described herein for continuous wet flex and abrasion, until the conductor had a DC resistance greater than about 100 ohms. The results are listed below as the number of hours of wet flex and abrasion until a resistance of greater than 100 ohms was reached. In all cases, no separation of the tape from the laminate was observed.

| | | Wash Hours |
|---|---|---|
| Example No. | Conductor Description | Until >100 ohms |
| Ex. 2 | MSTC-32 conductors | 22 hours |
| Ex. 3 | MSTC-16 conductors | 16 hours |
| Ex. 4 | Conductive silver tape ¼″ strip | 4 hours |
| Ex. 5 | Conductive silver tape ⅛″ strip | 2 hours |
| Ex. 6 | Microflat cable (4 conductors) | 2 hours |

### Examples 7-11

Conductive cables are described below for Examples 7-11. The conductive cables having lengths of about 60 cm were secured to 36 cm by 70 cm sections of 2L Gore-Tex® MI260 laminate as described in Examples 2-6 (W.L. Gore & Assoc., Inc., Elkton, Md.) with the same tape as Examples 2-6. The Gore seam sealing machine was used to secure the cables to the laminate, using an air nozzle temperature of about 625° C., a running speed of about 4.6 meters/minute, and air pressure of about 103.4 kPa. The cables were secured to the textile in a manner substantially similar to the methods of Examples 2-6.

For comparison, the conductive cables were also attached to laminate samples by way of tunnels. To accomplish this, a thin strip (5 cm by 55 cm) of 2L MI260 textile was stitched to the backside of the 2L MI260 panels using a commercial sewing machine and cotton thread. The strips of 2L MI260 were sewn along either side (lengthwise) of the strip along its length about one (1) cm in from either edge. The ends of each strip were left open (creating a tunnel) to allow for routing the cable. The cables were routed through the tunnels and taped only at the tunnel ends for about 6 cm on either end, using a 2L 0.1 millimeter tape as described in examples 2-6.

Both sets of samples were tested for wet flex and abrasion durability according to the test described herein. The table below compares the wet flex and abrasion hours between tunneled and taped samples, showing the hours at which the sample failed, or when resistance exceeded 100 ohms. The results of conductors that were routed in sewn tunnels and tape tacked on the ends are indicated as “Tunnel”. The results of the same conductors taped fully along their length are indicated as “Taped”.

| Example No. | Conductor | Tunnel | Taped |
|---|---|---|---|
| Ex. 7 | MSTC (32 wire) | 15 | >20 |
| Ex. 8 | MSTC (16 wire) | 11 | 20 |
| Ex. 9 | 3M Conductive tape | 1 | 5 |
| Ex. 10 | Aracon ® metal plated aramid yarn* | >2 | 9 |
| Ex. 11 | Headphone speaker wire** | 10 | 18 |

*DuPont
**multistrand 22 AWG, Radio Shack ®

### Example 12

The attachment of cables to a three dimensional fabric body is illustrated and tested for the washing durability of the cables attached by the methods of this invention.

A commercial jacket with a cell phone pocket (Authentic Brand Wear 1 First, size medium, JC Penneys) garment was retrofitted with cables secured to a the fabric with 2L 0.1 millimeter Gore-Seam tape (as described in examples 2-11). In this case, the tape was slit to a width of about 1.25 cm to further preserve the aesthetic.

A slit was cut into the jacket liner and the garment was inverted so that the sewn seams were exposed. Three MSTC (16 wire) cables (W.L. Gore & Assoc., Inc.) were extended along the seams of the jacket and covered with 0.1 millimeter 2L Gore Seam tape (slit to about 1.25 cm wide) using a crossover seam sealer press (George Knight and Co., Inc. Model 994-GS) with temperature set to 163° C. The tape and cable were laid on the jacket along three paths as described below, the cable being sandwiched between the tape and the jacket wherein the tape extended the length of the cable and extended beyond the edges of the cable. Each increment of tape and cable was held under the press for about 10 seconds, and the tape adhered to the jacket. The ends of each cable were left exposed and untaped for about 12 cm at each end.

One cable (cable 1) was laid along a seam and routed from the from the cell phone pocket to the left hand side of the hood and taped in place. The other two cables were routed along the seams and textile panels to the right hand side of the hood and taped in place. The two cables in the right hand side of the hood (cables 2 and 3) were laser stripped (25 W CO₂ laser) and soldered to the pretinned pads of a glass/epoxy circuit board with solder points covered by cyanoacrylate polymer. The cable end on the left hand side of the hood (cable 1) was also board terminated in substantially the same manner as cables 2 and 3. The opposite ends of all three cables were enclosed within the front, cell phone pocket on the garment. Cables 1 and 2 were stripped and terminated to boards. The third cable (cable 3) was left unterminated to assess the impact of not having a termination in the cell phone pocket. All circuit boards and the remaining lengths of free cable were taped to the garment using the same method and tape as used with the cable.

The garment was subjected to wash/dry cycles according the method described herein. The DC resistance of the conductor in all three cables was measured, using the Fluke 21 III multi-meter described above, after each wash/dry cycle using the test method described herein for wash/dry cycles. The table below shows the results of the durability study. There was no visible separation of the tape from the textile through the wash/dry process.

Number of Wash/Dry Cycles

| | Initial | 1 | 2 | 3 | 4 | 5 |
|---|---|---|---|---|---|---|
| Cable 1 | 2.7 Ω | 5.5 Ω | 5 Ω | 6 Ω | 5.5 Ω | 400 MΩ(connector |
| | | | | | | damaged in wash) |
| Cable 2 | 2.5 Ω | 9 Ω | 8.5 Ω | 8 Ω | 9 Ω | 9 Ω |
| Cable 3 | NA | 9 Ω | 2.5 Ω | 8 Ω | 5 Ω | 9 Ω |

### Example 13

A fully sewn jacket was assembled from a textile (three layer GORE-TEX® fabric, W.L. Gore & Assoc., Inc., Elkton, Md.). An interconnect system having connectors for four (4) electronic modules was assembled from three twelve (12) conductor ribbon cables (Gore MSTC 12, W.L. Gore & Associates, Pleinfeld, Germany) by soldering the appropriate wires in the ribbon cables to a terminal board. An acrylic pressure sensitive adhesive transfer tape was slit to 2.5 millimeter width and applied to one side of the ribbon cables which have a width of three (3) millimeters. Release paper was removed from the adhesive transfer tape and the cable was routed on the inner side of the garment along garment seams and across the textile panels and seams by pressing the cable and pressure sensitive adhesive to the textile with a finger.

The cable was placed to connect the electronic modules at specific locations on the garment, i.e., the hood, each arm, and the left chest area. The pressure sensitive adhesive provided attachment of the cable to the textile until the cable was secured by tape. The cables were then covered and secured to the garment with a tape (Gore 3 Layer seam tape, light gray, 22 millimeters wide, WL Gore & Assoc. Inc., Elkton, Md.) by covering the entire length of each cable with the tape which extended beyond the cable side surfaces. Heating and pressing the tape covered cable and textile was performed incrementally in a crossover press (Model 994-GS, George Knight, Ltd., UK), adhering the tape to the textile and thereby securing the cable to the garment. Pressing was for 10 seconds with an upper platen temperature of 163° C. The tape had a 0.15 millimeter layer of polyurethane adhesive, a 25 micrometer layer of microporous PTFE, and a layer of knit fabric. The tape crossed over at least one seam joining textile panels.

The portion of the seam covered by the tape and the textile were tested for liquidproofness and found to pass a Suter test (when performed substantially according to the method described herein). The electronic modules were attached to the harness and performed as desired.

### Example 14

The bending stiffness of cables is assessed. The bending stiffness of textiles having cables secured thereto by the attachment methods of the present invention is tested.

The bending stiffness of the taped samples of Examples 7 and 8, and the textile used to form these samples was tested using the Handle-O-Meter test as described herein. Additionally, other cable types were tested.

Another sample was prepared substantially according to Example 11 using headphone speaker wire, 4 mil Gore seam tape, and taping process conditions as described in Example 11. The textile surface used was 2L US101 Gore-Tex® Laminate, a 75 g/m² polyester fabric laminated to a membrane comprising ePTFE. The sample and the textile used to make this sample were tested for bending stiffness. The results are reported in the table below.

| | Bending Stiffness |
|---|---|
| Sample Description | (Hand Number in Grams) |
| Taped samples of Example 7 | 102 g |
| Taped samples of Example 8 | 101 g |
| 2L MI260 textile of Examples 7 and 8 | 29 g |
| 2L US101 and headphone speaker wire | 758 g |
| 2L US101 textile | 55 g |
| MSTC 16 ribbon cable | 25 g |
| MSTC 32 ribbon cable | 50 g |
| Headphone speaker wire in example 11 | 164 g |
| 3M Conductive Tape (3224-1) 2 cm width | 437 g |
| 22 AWG multi-strand speaker wire | 488 g |
| 22 AWG single strand wire | >1000 g |

The table includes results reported in grams for both textiles, and textile comprising cables secured by tape.

1. A method of applying a cable to a fabric body comprising
joining at least two textile panels to form a fabric body comprising a seam;
extending a length of cable having cable side surfaces, across the seam onto a portion of at least two textile panels;
providing a tape comprising an adhesive, adhering the tape adhesive to the cable length across the seam, the tape covering the cable length, and extending beyond the cable side surfaces; and
the tape adhesive adhering the tape to the fabric body, thereby securing the cable to the fabric body.

2. The method of claim 1 wherein the cable remains secured to the fabric body for at least two wash cycles.

3. The method of claim 1 further comprising securing the cable between the tape and the fabric body.

4. The method of claim 1 wherein the steps of extending a length of cable and providing a tape are concurrent.

5. The method of claim 1 further comprising the step of applying an additional adhesive across at least two textile panels prior to the step of extending a length of cable.

6. The method of claim 5 wherein the step of extending a length of cable comprises extending the length of cable on the adhesive, and adhering the cable to the adhesive.

7. The method of claim 1 wherein the cable comprises an adhesive on a cable surface, further comprising the step of adhering the length of cable to the textile panels prior to the step of providing a protective tape.

8. The method of claim 1 further comprising the steps of providing connectors and terminating the cable with connectors.

9. The method of claim 8 further comprising covering the connectors with the tape comprising adhesive, the adhesive extending beyond connector edges and onto the textile panels, and securing the connectors to the fabric body.

10. The method of claim 1 wherein the fabric body is a personal shelter.

11. The method of claim 1 wherein the fabric body is a garment.

12. The method of claim 1 wherein the fabric body is a jacket.

13. A method of applying a cable to a fabric body comprising
providing a fabric body having at least one textile panel;
providing a seam tape sealing machine comprising a tape reel, the tape reel having a tape comprising an adhesive, a heating component, and two rolls;
extending a length of cable having cable side surfaces, across at least a portion of at least one textile panel;
feeding the tape from the tape reel onto the length of cable and covering the length of cable with the tape;
melting the tape adhesive with the heating component;
feeding the textile having the tape and cable through the two rollers; and
adhering the tape adhesive along the length of the cable, the tape adhesive extending beyond the cable side surfaces onto the textile panel thereby
securing the cable between the tape and the textile panel.

14. The method of claim 13 wherein the seam sealing machine further comprises a cable reel and wherein the cable is fed from the reel concurrently with the step of feeding the tape.

15. The method of claim 13 further comprising the step of adhering the cable to the textile with an additional adhesive prior to the step of covering the cable with the tape.

16. The method of claim 13 wherein the fabric body is a garment.

17. The method of claim 13 wherein the fabric body is a jacket.

18. (canceled)

19. (canceled)

20. The method of claim 44 further comprising extending the tape adhesive over cable side surfaces onto the textile surface.

21. (canceled)

22. The method of claim 44 wherein the cable comprises a thermally stable insulating layer.

23. The method of claim 44 wherein the textile is fabric body.

24. The method of claim 44 wherein the fabric body is a garment.

25. The method of claim 24 wherein the garment is a jacket.

26. The method of claim 24 wherein the garment is a glove.

27. The method of claim 24 wherein the garment is a shirt.

28. The method of claim 24 wherein the garment is a hood.

29. The method of claim 23 wherein the fabric body is a personal shelter.

30. The method of claim 29 wherein the personal shelter is a tent.

31. (canceled)

32. The method of claim 44 wherein the textile is liquidproof.

33. The method of claim 44 wherein the fabric body is liquidproof.

34. The method of claim 44 wherein the fabric body is moisture vapor permeable.

35. The method of claim 44 wherein the steps of extending a length of cable and providing a tape are concurrent.

36. The method of claim 44 further comprising the step of adhering an additional adhesive in a pattern across the textile prior to the step of extending a length of cable and providing a tape.

37. The method of claim 44 wherein the tape adhesive is a polyurethane.

38. The method of claim 36 wherein the additional adhesive is a pressure sensitive adhesive.

39. The method of claim 36 wherein the step of extending a length of cable further comprises extending the length of cable on a length on the additional adhesive, and adhering the cable to the length of adhesive.

40. The method of claim 44 wherein the cable comprises an additional adhesive on a cable surface.

41. The method of claim 44 further comprising the step of adhering the cable to the textile surface, prior to the step of securing the

42. (canceled)

43. The method of claim 44 wherein the connectors are secured to the textile with a tape applied by a garment taping process.

44. A method of making a fabric body in which power or data can be transmitted across a seam, comprising
providing a textile comprising at least two joined panels comprising a seam and a textile surface;
providing an interconnect system comprising a length of cable having cable ends, connectors to terminate the cable ends, and at least two electronic devices to connect to the connectors;
extending the length of cable across the seam;
covering the length of cable with the tape comprising a tape adhesive;
securing the length of cable to the textile surface with the tape adhesive; and
terminating the cable ends with connectors to connect to electronic devices, and securing the connectors to the textile surface by covering the connectors with the tape adhesive;
wherein the interconnect system is capable of transmitting power or data between electronic devices.
